(19) United States
(12) Patent Application Publication
(10) Pub. No.: US 2010/0110578 A1
(43) Pub. Date: May 6, 2010

(54) SIGNAL AMPLIFIER AND STORAGE DEVICE

(75) Inventor: Yoshihiro Amemiya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/560,922

(22) Filed: Sep. 16, 2009

(30) Foreign Application Priority Data
Oct. 31, 2008 (JP) 2008-280756

(51) Int. Cl. G11B 5/02

(52) U.S. Cl. 360/67; G9B/5.026

(57) ABSTRACT

According to one embodiment, a signal amplifier amplifies a read signal read from a storage medium by a head, and includes an amplifier, a detector, and an impedance controller. The amplifier amplifies the read signal received from the head to obtain an amplified signal, and varies the input impedance of the read signal based on a control signal. The detector detects the frequency characteristic of the amplified signal output from the amplifier and determine the frequency characteristic as a first frequency characteristic. The impedance controller generates the control signal such that the first frequency characteristic detected by the detector becomes a predetermined second frequency characteristic.

### CROSS-REFERENCE TO RELATED APPLICATIONS

This application is based upon and claims the benefit of priority from Japanese Patent Application No. 2008-280756, filed Oct. 31, 2008, the entire contents of which are incorporated herein by reference.

### BACKGROUND

1. Field

One embodiment of the invention relates to a signal amplifier which amplifies a read signal read from a storage medium by a head, and a storage device.

2. Description of the Related Art

In a magnetic storage device, a preamplifier amplifies a signal from an Magneto Resistive (MR) head to adjust it to be easily read by an Read Channel (RDC). With conventional technologies, since the band of the magnetic storage device depends upon the band of the preamplifier, a transfer rate at the time of reading in the magnetic storage device is increased by improving the band characteristics of the preamplifier.

On the other hand, as the band of the preamplifier is sufficiently satisfied, the head-transmission path band degrades. Consequently, a signal may not be accidentally input to the preamplifier due to band limitation of the head-transmission path band which has not adversely influenced at a conventional use frequency. This is because the inductance component of the transmission path and the input resistance and parasitic capacitance of the preamplifier form a low-pass filter. As countermeasures against this situation, a target transfer performance can be achieved by optimum design of a head-transmission path model and adjustment based on actual measurement.

On the other hand, storage device products of various sizes and rotational speeds have been available on the market. There are many types of mechanisms comprising transmission paths. The preamplifier is largely influenced by, in particular, transmission path characteristics from the head. To achieve optimum write/read characteristics, a circuit is optimally adjusted by simulating the circuit using a transmission path model.

There have been proposed some conventional technologies. Examples of the conventional technologies include a disk device which corrects an output decrease of a read signal in high frequency band due to deficient characteristics of a medium, an automatically adjusting method for adjusting a reproducing parameters according to environmental fluctuations of a head, and a bias circuit for an MR head (see, for example, Japanese Patent Application Publication (KOKAI) No. H07-244809, Japanese Patent Application Publication (KOKAI) No. H08-293165, and U.S. Pat. No. 7,251,091).

With the conventional technologies, if a slight change or a large fluctuation occurs in a head or a transmission path, a target transfer performance may not be achieved. In particular, an MR element is a TuMR, and therefore, a resistance is fluctuated in several hundreds ohms. The resistance is gradually increased for the improvement in S/N. If a design is optimized for every change in resistance, revision or the like causes an increase in cost and a delay in a schedule.

In addition, the actual measurement is always influenced by a probe or a measuring jig. Therefore, it is difficult to detect accurate transfer in a magnetic storage device. Under current circumferences, it is not possible to directly detect the characteristics comprising those of the preamplifier, the head, and the transmission path.

Moreover, a single preamplifier may be currently used in a plurality of devices for the short-term development and cost reduction. The merits described above can be acquired by sharing the single preamplifier. However, although all of members inclusive of the transmission path need be shared to achieve optimum transfer, the length of the transmission path depends upon the diameter of a magnetic disk, and further, the design of the transmission path per se is frequently varied for the mass production. Accordingly, it is difficult to maintain the same characteristics.

### BRIEF DESCRIPTION OF THE SEVERAL VIES OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an HDD according an embodiment of to the invention;

FIG. 2 is an exemplary circuit diagram of a read amplifier in the embodiment;

FIG. 3 is an exemplary circuit diagram of a simple model of a read head to the read amplifier in the embodiment;

FIG. 4 is an exemplary graph of a simulation result of a read band in the embodiment;

FIG. 5 is an exemplary sequence chart of preamplifier adjusting processing before shipment by the HDD in the embodiment;

FIG. 6 is an exemplary timing chart of the preamplifier adjusting processing at the time of start up by the HDD in the embodiment;

FIG. 7 is an exemplary circuit diagram of a read amplifier of a first example in the embodiment;

FIG. 8 is an exemplary circuit diagram of a read amplifier of a second example in the embodiment;

FIG. 9 is an exemplary circuit diagram of a read amplifier of a third example in the embodiment; and

FIG. 10 is an exemplary circuit diagram of a read amplifier of a fourth example in the embodiment.

### DETAILED DESCRIPTION

Various embodiments according to the invention will be described hereinafter with reference to the accompanying drawings. In general, according to one embodiment of the invention, a signal amplifier amplifies a read signal read from a storage medium by a head, and comprises an amplifier, a detector, and an impedance controller. The amplifier is configured to amplify the read signal received from the head to obtain an amplified signal, and vary the input impedance of the read signal based on a control signal. The detector is configured to detect the frequency characteristic of the amplified signal output from the amplifier and determine the frequency characteristic as a first frequency characteristic. The impedance controller is configured to generate the control signal such that the first frequency characteristic detected by the detector becomes a predetermined second frequency characteristic.

According to another embodiment of the invention, a storage device comprises an instructing module, a head, an amplifier, a detector, and an impedance controller. The instructing module is configured to instruct to read predetermined information on a storage medium. The head is configured to read the information and output the information as a read signal. The amplifier is configured to amplify the read signal received from the head to obtain an amplified signal, and vary the input impedance of the read signal based on a control signal. The detector is configured to detect the frequency characteristic of the amplified signal output from the amplifier and determine the frequency characteristic as a first frequency characteristic. The impedance controller is configured to generate the control signal such that the first frequency characteristic detected by the detector becomes a predetermined second frequency characteristic.

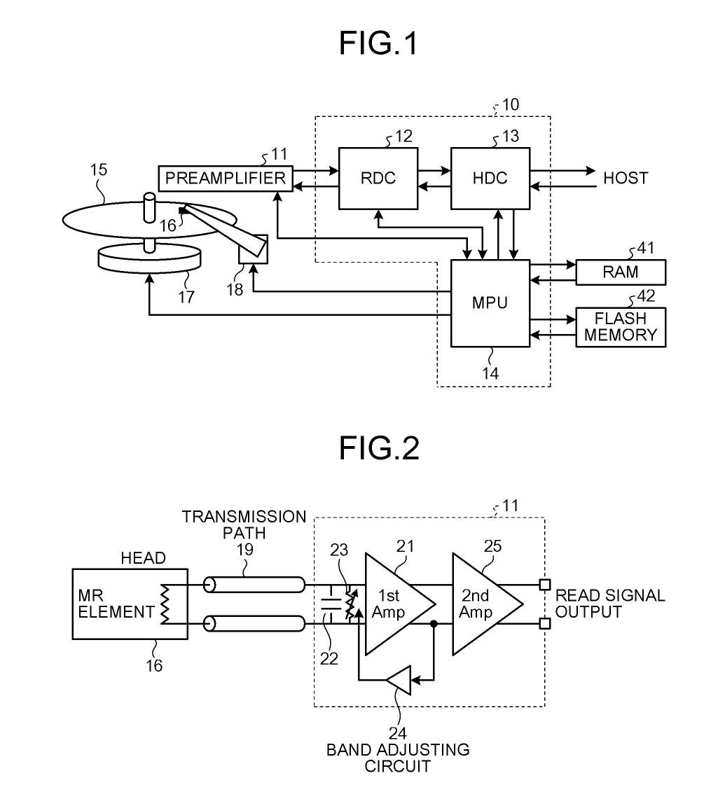

FIG. 1 is a block diagram of a configuration of an HDD according to an embodiment of the invention. The HDD comprises a control chip 10, a preamplifier (signal amplifier) 11, a disk 15 (storage medium), a head 16, an Spindle Motor (SPM) 17, a Voice Coil Motor (VCM) 18, and a transmission path 19. An RDC 12, an Hard Disk Controller (HDC) 13, and a Micro Processing Unit (MPU) 14 serves as an instructing module. The control chip 10 comprises the RDC 12, the HDC 13, the MPU 14, a RAM 41, and a flash memory 42.

The head 16 comprises a read head (or an MR head) and a write head. The read head is adapted to output a read signal read from the disk 15 to the preamplifier 11 through the transmission path 19. The write head is adopted to write a write signal input through the transmission path 19 on the disk 15. The preamplifier 11 comprises a read amplifier for amplifying the read signal input from the read head through the transmission path 19 to output the amplified signal to the RDC 12, and a write amplifier for amplifying a write signal input from the RDC 12 to output the amplified signal to the write head through the transmission path 19. The transmission path 19 comprises a read transmission path for connecting the read head and the read amplifier to transmit the read signal and a write transmission path for connecting the write amplifier and the write head to transmit the write signal.

The RDC 12 modulates write data input from the HDC 13 to output the modulated write data to the preamplifier 11 as the write signal whereas demodulates the read signal input from the preamplifier 11 to output the demodulated read signal to the HDC 13 as read data. The HDC 13 receives a command from a host, and then, outputs the read data input from the RDC 12 to the host in response to a read command whereas the HDC 13 outputs the write data input as a write command from the host to the RDC 12. The MPU 14 executes, on the RAM 41, firmware stored in the flash memory 42, to control the preamplifier 11, the RDC 12, the HDC 13, the SPM 17, and the VCM 18.

The SPM 17 makes the disk 15 rotate in accordance with an instruction from the MPU 14. The VCM 18 makes the head 16 move in accordance with an instruction from the MPU 14.

An input impedance at the time of input of the signal from the read head in the read amplifier relates to the band of the read head and the read transmission path.

In the read amplifier of the preamplifier 11, the input impedance (Rin or Zin) can be freely changed. An amplifier circuit having a variable input impedance Rin is exemplified by that of a Vbias-Isence type or a Vbias-Vsence type, as disclosed in, for example, U.S. Pat. No. 7,251,091.

In the case of the Vbias-Isence type, the read amplifier can analogously adjust the input impedance Rin. As an adjusting method, the input impedance Rin can be varied by increasing or decreasing a current drawn by an emitter (Tail Current). In the case of the Vbias-Vsence type, the resistance of the input impedance Rin needs to be varied.

FIG. 2 is a circuit diagram of the read amplifier of the embodiment. The read amplifier comprises a first amplifier circuit 21 (amplifier), a parasitic capacitance 22, a band adjusting circuit 24 (detector and impedance controller), and a second amplifying circuit 25 (amplitude adjuster). The first amplifier circuit 21 comprises an input resistance 23.

The band adjusting circuit 24 is provided for detecting a read band (frequency characteristics between the read head and the read transmission path or frequency characteristics of a read amplifier input). The band adjusting circuit 24 performs read band adjusting processing of adjusting the read band in the read amplifier. In the read band adjusting processing, the band adjusting circuit 24 first detects a signal level (first frequency characteristic) of a predetermined plurality of frequency components. Next, the band adjusting circuit 24 generates a control signal such that the detected plurality of frequency components have desired frequency characteristics (target read band, second frequency characteristic), and then, the first amplifier circuit 21 varies the input impedance Rin according to the control signal, thereby optimizing the read band.

The variation of the input impedance Rin induces variations of a signal amplitude input into the first amplifier circuit 21 due to the resistance of the head 16 or the resistor division of the input impedance Rin. This variation apparently appears as a change in gain of the first amplifier circuit 21, thereby influencing on the amplification factor of the entire read amplifier. To absorb the variation of the amplification factor, an Automatic Gain Control (AGC) circuit is used in combination as the second amplifying circuit 25. The second amplifying circuit 25 may be implemented by using a variable amplifier or a variable attenuator. Alternatively, the second amplifying circuit 25 may be eliminated by providing the AGC circuit at a rear stage of the preamplifier 11 such as in the RDC 12.

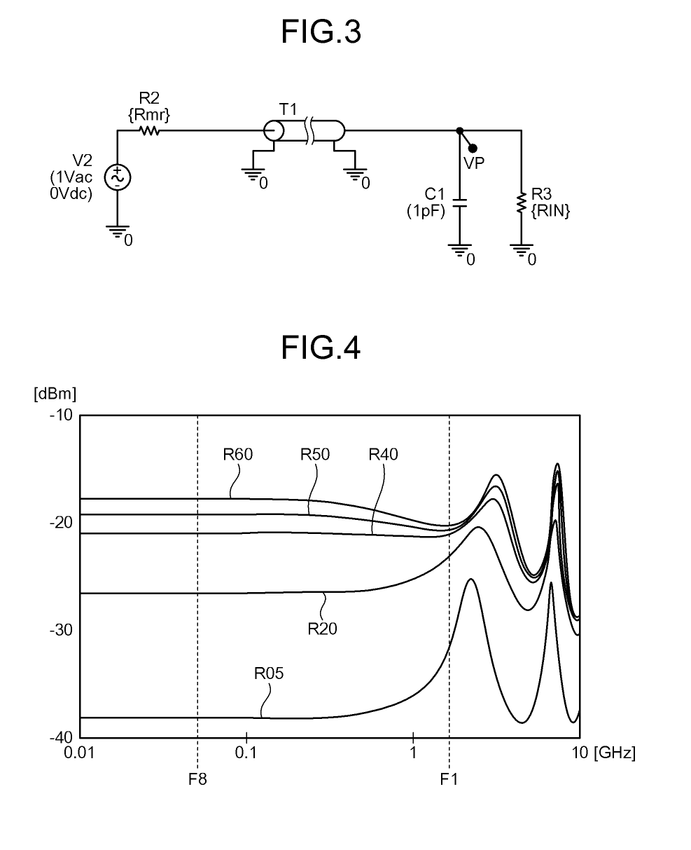

FIG. 3 is a circuit diagram of a simple model of the read head and the read amplifier of the embodiment. In this simple model, the read head is represented by a voltage source V2 and a resistance R2. A read transmission path T1 has an inductance L. The input impedance (input resistance 23) of the read amplifier is represented by R3 (Rin) whereas the parasitic capacitance 22 determined by packaging or the like corresponds to C1.

Upon measurement by a probe VP in FIG. 3, a cutoff frequency is determined by the inductance L of the transmission path T1 and the capacitance C1. The capacitance C1 is assumed to be 1 pF. In addition, a peak of LRC is generated by the impedance R3.

A simulation result of a read band using the above simple model is illustrated. FIG. 4 is a graph of the simulation result of the read band according to the embodiment. In FIG. 4, the horizontal axis represents a frequency while the vertical axis represents a signal level at the read amplifier input. Curves R05, R20, R40, R50, and R60 in FIG. 4 indicate simulation results in which the resistance of the impedance Rin are set to 5Ω, 20Ω, 40Ω, 50Ω, and 60Ω, respectively. On the axis indicating the frequency in FIG. 4, there are illustrated a maximum transfer frequency F1 (Data rate target) indicating a maximum transfer rate and a reference transfer frequency F8 (Base target, about 50 MHz to about 100 MHz) that indicates a reference transfer rate, which is ⅛ of the maximum transfer rate, and that is a frequency with sufficiently little interference and is to be a reference of a gain.

Based on the read band simulation result, an amplification factor at the frequency F8 is different from that at the frequency F1. The read band can be varied by varying the impedance Rin.

However, the variation of the impedance Rin leads to variations of the gain in the read amplifier. To the contrary, the read amplifier output can be kept constant by combining the second amplifying circuit 25 serving as the AGC circuit with the first amplifying circuit 21, the second amplifying circuit 25 provided at the rear stage thereof.

Preamplifier adjusting processing before shipment in the HDD will be described below.

The read band adjusting processing of the embodiment is performed in a test before shipment from a factory, for example. A gain may vary according to the result of the read band adjusting processing. Therefore, if the read band adjusting processing is performed in a sequence at the time of power ON, start up time is prolonged. Therefore, in the preamplifier adjusting processing before shipment, the HDD first performs the read band adjusting processing, and then, performs gain adjusting processing in which the gain of the read amplifier is adjusted.

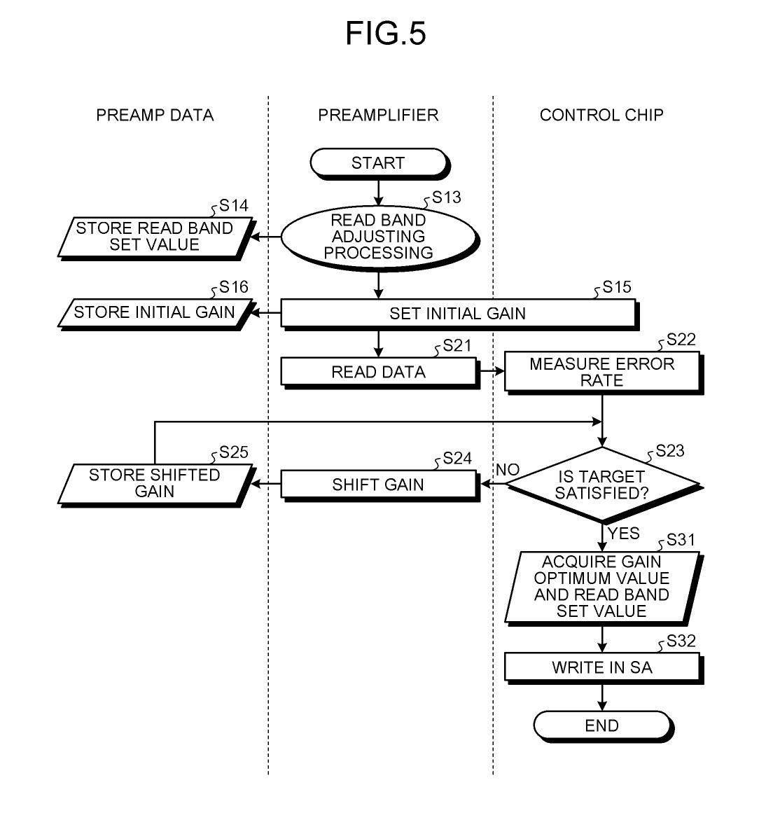

FIG. 5 is a sequence chart of the preamplifier adjusting processing before shipment by the HDD. A time axis in FIG. 5 orients downward. In addition, three parallel columns in FIG. 5 illustrate a set value (Preamp Data) stored in the preamplifier 11, the operation of the preamplifier 11, and the operation of the control chip 10, respectively, from left.

First, when the MPU 14 gives an instruction of the preamplifier adjusting processing before shipment, the preamplifier 11 performs the read band adjusting processing (S13). The preamplifier 11 stores a read band set value as a set value of the tail current or the like set by the read band adjusting processing (S14).

In subsequent S15 to S25, the gain adjusting processing is performed. First of all, the control chip 10 sets an initial gain in the preamplifier 11 (S15). The preamplifier 11 stores the set initial gain (S16).

Next, the preamplifier 11 outputs the read signal, from which the head 16 reads data, into the RDC 12 (S21). The RDC 12 demodulates the read signal to measure an error rate (S22). Thereafter, the HDC 13 determines whether or not the measured error rate satisfies a target value (S23).

If the measured error rate does not satisfy the target value (No at S23), the preamplifier 11 shifts the gain by a predetermined number of steps (S24). The preamplifier 11 stores the shifted gain (S25). Next, this flow transits to S21.

If the measured error rate satisfies the target value (Yes at S23), the control chip 10 acquires a gain optimum value, which is a final gain, and the read band set value from the preamplifier 11 (S31), and then writes the gain optimum value and the read band set value in an System Area (SA) as Status (S32) to end this sequence.

The set values, which are analog values or digital values set by the preamplifier 11 in the preamplifier adjusting processing before shipment, such as the gain optimum value and the read band set value may be stored on the SA on the disk 15 or a nonvolatile storage medium such as the flash memory 42 in S27. The HDD stores the set values in the preamplifier adjusting processing before shipment, to read and reset the stored set value at the time of start up, thereby the start up time can be shortened.

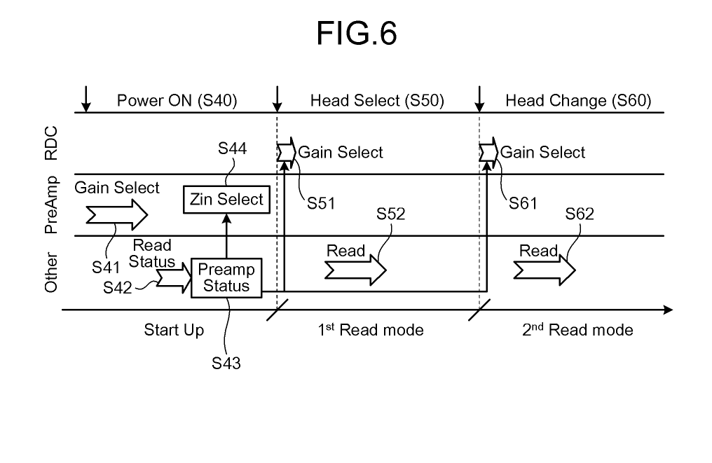

However, in the case of a preamplifier having a multi-valued gain, the read signal may not be read with the initial gain. In view of this, the HDD may perform the gain adjusting processing to read the SA as preamplifier adjusting processing upon start up to be performed when powered on and set the read band set value, then the HDD may perform the gain adjusting processing to set the optimum gain. FIG. 6 is a timing chart of the preamplifier adjusting processing upon start up by the HDD. A time axis in FIG. 6 orients rightward. In addition, three parallel columns in FIG. 6 illustrate operations of the RDC 12, the preamplifier 11 (Preamp), and the other members (Other) from top.

First, when the HDD is powered on (Power On, S40) the HDD performs start-up (Start UP) processing. At this time, the preamplifier 11 performs the gain adjusting processing to read the SA (S41). Next, the HDC 13 and the RDC 12 read a Status from the SA (S42) and set it in the preamplifier 11 (S43). The preamplifier 11 stores the Status as a set value (S44).

When the HDD selects a head (Head Select, S50) the HDD performs first read processing (1st Read mode). At this time, the RDC 12 instructs the preamplifier 11 to perform the gain adjusting processing (S51), and performs reading after the gain adjusting processing (S52).

Similarly, when the HDD change the head (Head Change, S60), the HDD performs second read processing (2nd Read mode). At this time, the RDC 12 instructs the preamplifier 11 to perform the gain adjusting processing (S61), and then, performs reading after the gain adjusting processing (S62).

A calibration signal previously written in the disk 15 as a signal read in the read band adjusting processing is desirably a signal comprising a frequency component of a wide band. In view of this, data to be written by alternating current (AC) erase is formed in a random pattern, thus producing the calibration signal having the frequency component of a wide band. Another calibration signal may be a signal obtained by adding sinusoidal waves of a plurality of frequencies detected by the band adjusting circuit 24 in the read band adjusting processing. Alternatively, the calibration signal may be replaced with a servo signal or the AC erase.

The read band adjusting processing may be performed not only at the time of the shipment from the factory but also after the shipment by using such a calibration signal.

The read band adjusting processing may be used for abnormality detection and adjustment after the shipment. The optimum set value of the read amplifier may be possibly varied due to a change in MR element resistance or transmission path characteristics across ages after the shipment of the HDD. In particular, the MR element resistance may be varied significantly, and thus there may be a case that the read signal cannot be read in the HDD having a high transfer rate in recent years. In view of this, the band adjusting circuit 24 monitors an influence of the aging degradation at predetermined time interval to perform the read band adjusting processing. The resultant set value is written in the nonvolatile storage medium such as the SA. With such read band adjusting processing after the shipment, it is possible to cope with the aging degradation.

Examples of the read amplifier of the embodiment will be described below.

The first amplifying circuit 21 is of a Vbias-Isence type in the first example.

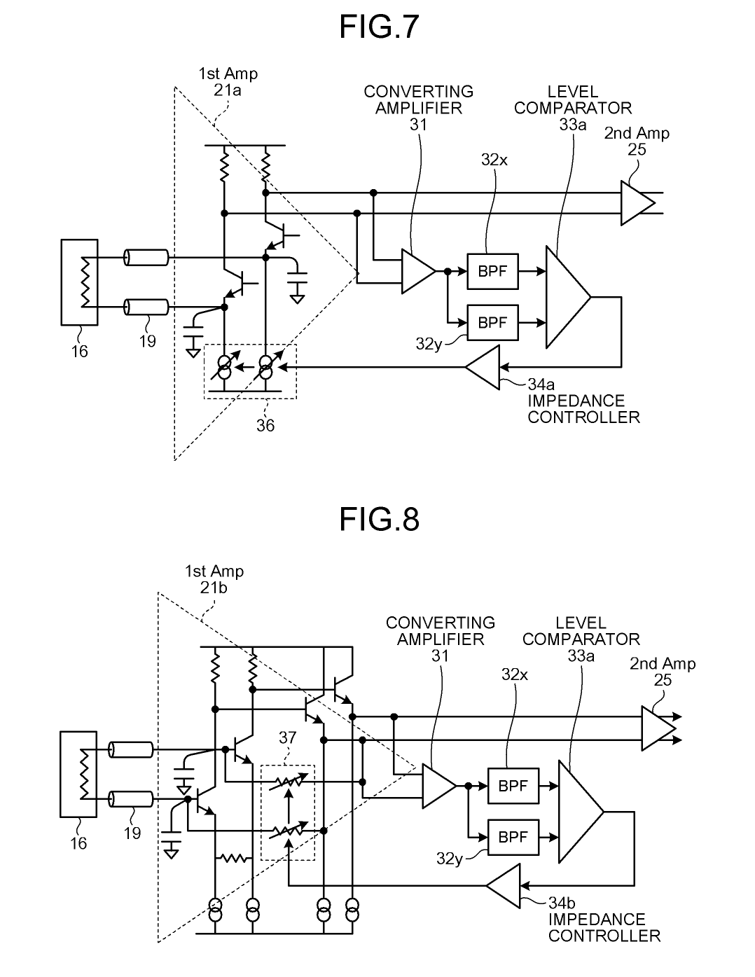

FIG. 7 is a circuit diagram of the read amplifier of the first example. The read amplifier comprises a first amplifying circuit 21a, the second amplifying circuit 25, a converting amplifier 31, Band Pass Filters (BPFs) 32x and 32y, a level comparator 33a, and an impedance controller 34a. The first amplifying circuit 21a of a Vbias-Isence type comprises a variable current source 36. With a current (Tail Current) from the variable current source 36, the input impedance can be varied. The second amplifying circuit 25 is the AGC circuit, as described above, and controls the amplification factor in such a manner that an output level is kept constant.

The operation of the read amplifier of the first example will be described below.

The converting amplifier 31 converts a differential output from the first amplifying circuit 21a into a single-ended signal. The BPF 32x allows an output having the frequency F8 out of the outputs from the converting amplifier 31 to pass therethrough. In contrast, the BPF 32y allows an output having the frequency F1 out of the outputs from the converting amplifier 31 to pass therethrough.

The level comparator 33a compares the levels of the outputs of the frequencies F1 and F8 with each other. The impedance controller 34a generates a control signal to the first amplifying circuit 21a in such a manner that the levels of the outputs of the frequencies F1 and F8 match (i.e., the read band is made flat) based on the preset relationship between the magnitude relationship of the levels of the outputs of the frequencies F1 and F8 and the tail current and an output from the level comparator 33a to optimize the input impedance Rin of the first amplifying circuit 21a. The variable current source 36 in the first amplifying circuit 21a varies the tail current according to the control signal.

When the impedance controller 34a increases the Tail Current in the first amplifying circuit 21a, the ON resistance of a transistor is decreased, and thus the input impedance Rin becomes low. When the impedance controller 34a decreases the Tail Current in the first amplifying circuit 21a, the ON resistance of the transistor is increased, and thus the input impedance Rin becomes high. In the case where the level of the reference transfer frequency is low, like the read band simulation results R05 and R20, an impedance controller 34 increases the Tail Current in the first amplifying circuit 21a to decrease the input impedance Rin. Accordingly, the read band can be adjusted to become flat.

When the input impedance Rin is changed, the gain in the first amplifying circuit 21a is also changed. However, the gain of the entire read amplifier can be made constant when the second amplifying circuit 25 as the AGC circuit adjusts the gain.

The calibration signal of the embodiment comprises at least, for example, the sinusoidal wave of the frequency F8 and the sinusoidal wave of the frequency F1 in accordance with the passing frequencies of the BPFs 32x and 32y. Otherwise, the calibration signal may be an AC erase signal of a wide band comprising the outputs of the frequencies F1 and F8. Alternatively, the passing frequency of the BPF 32y is set to be a frequency F2 which is ½ of the maximum transfer frequency, and the calibration signal may be a signal obtained by adding the sinusoidal wave of the frequency F8 to the sinusoidal wave of the frequency F2.

The first amplifying circuit 21 is of a Vbias-Vsence type in the second example.

FIG. 8 is a circuit diagram of the read amplifier of the second example. In FIG. 8, the same or corresponding components as or to those illustrated in FIG. 7 are designated by the same reference numerals, and their description will not be repeated. Compared with the read amplifier of the first example, the read amplifier of the second example comprises a first amplifying circuit 21b in place of the first amplifying circuit 21a and an impedance controller 34b in place of the impedance controller 34a. The first amplifying circuit 21b of a Vbias-Vsence type comprises a variable resistance 37. With the resistance of the variable resistance 37, an input impedance can be varied.

The operation of the read amplifier of the second example will be described below.

The converting amplifier 31 converts a differential output from the first amplifying circuit 21b into a single-ended signal. The BPF 32x allows an output of the frequency F8 out of the outputs from the converting amplifier 31 to pass therethrough. In contrast, the BPF 32y allows an output having the frequency F1 out of the outputs from the converting amplifier 31 to pass therethrough.

The level comparator 33a compares the levels of the outputs of the frequencies F1 and F8 with each other. The impedance controller 34b generates a control signal to the first amplifying circuit 21b in such a manner that the levels of the outputs of the frequencies F1 and F8 match with each other (i.e., the read band is made flat) based on the preset relationship between the magnitude relationship of the levels of the outputs of the frequencies F1 and F8 and the resistance of the variable resistance 37 and the output from the level comparator 33a to optimize the input impedance Rin of the first amplifying circuit 21b. The variable resistance 37 in the first amplifying circuit 21b switches its resistance according to the control signal.

The impedance controller 34b switches the resistance of the variable resistance 37 in the first amplifying circuit 21b, thereby varying the input impedance Rin in the first amplifying circuit 21b. In the case where the level of the reference transfer frequency is low, like the read band simulation results R05 and R20, the resistance of the variable resistance 37 in the first amplifying circuit 21b is switched to decrease the input impedance Rin. Accordingly, the read band can be adjusted to become flat.

For the read amplifiers of the first and second examples, measurement targets are the signal levels at the two points on the frequency axis (reference transfer frequency and maximum transfer frequency). A read amplifier of the third example is adapted to measure signal levels on three or more points.

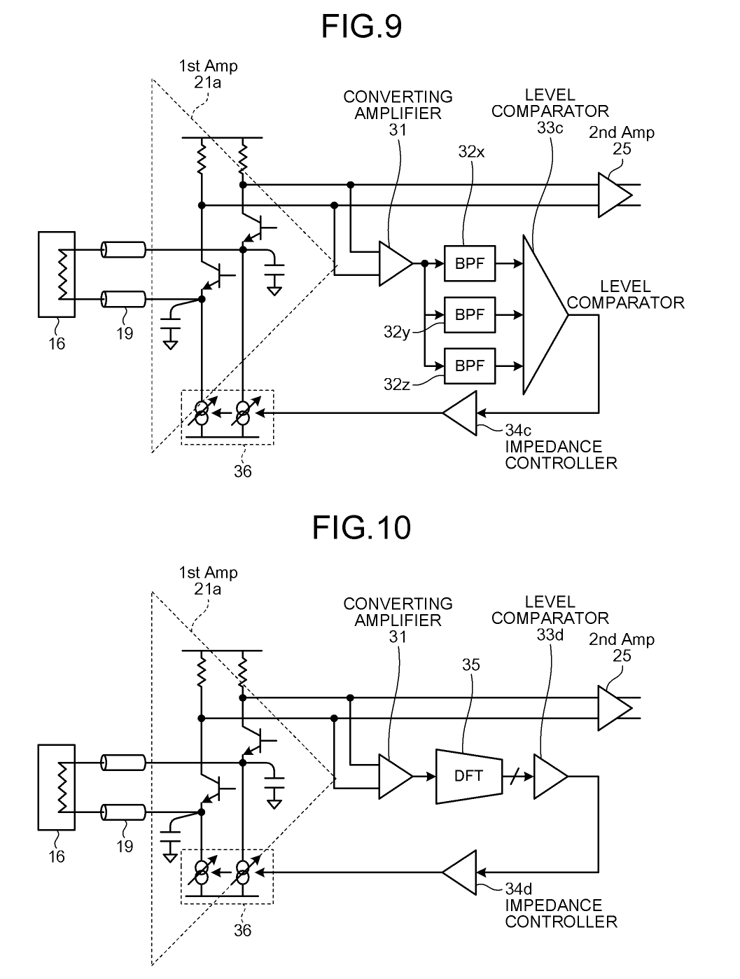

FIG. 9 is a circuit diagram of the read amplifier of the third example. In FIG. 9, the same or corresponding components as or to those illustrated in FIG. 7 are designated by the same reference numerals, and their description will not be repeated. Compared with the read amplifier of the first example, the read amplifier of the third example further comprises a BPF 32z and comprises a level comparator 33c in place of the level comparator 33a and an impedance controller 34c in place of the impedance controller 34a.

The operation of the read amplifier of the third example will be described only as to the difference from that of the first example.

The BPF 32z allows a frequency F0 other than the reference transfer frequency and the maximum transfer frequency to pass therethrough.

The level comparator 33c compares signal levels of frequencies F8, F1, and F0. In the case where the read head and the read amplifier show the above-described read band simulation result, the frequency F0 is set to 2 GHz to 3 GHz besides the frequencies F8 and F1 so that a resonance peak appearing therearound can be detected.

The impedance controller 34c generates a control signal to the first amplifying circuit 21a based on an output from the level comparator 33c to optimize the input impedance Rin to the first amplifying circuit 21a. In a result of the above-described read band simulation result, when the impedance controller 34c decreases the input impedance Rin, the peak of the resonance is moved toward a higher frequency, although a gain is decreased on the way. This decrease is detected at the frequency F0, and then, the adjustment of decreasing the input impedance Rin is finished or an adjustment of increasing the input impedance Rin is performed.

When three or more BPFs are provided to detect the signal levels at three or more frequencies as in the third example, the accuracy of the detection of the read band can be enhanced and the accuracy of the adjustment to a desired read band can be improved.

The calibration signal of the third example comprises, for example, at least the sinusoidal wave of the frequency F8, the sinusoidal wave of the frequency F1, and the sinusoidal wave of the frequency F0 in accordance with the passing frequencies of the BPFs 32x, 32y, and 32z. Otherwise, the calibration signal may be an AC erase signal of a wide band comprising the frequencies F1, F8, and F0.

A Discrete Fourier Transform (DFT) circuit is used as a read amplifier in the fourth example.

FIG. 10 is a circuit diagram of the read amplifier of the fourth example. In FIG. 10, the same or corresponding components as or to those illustrated in FIG. 7 are designated by the same reference numerals, and their description will not be repeated. Compared with the read amplifier of the first example, the read amplifier of the fourth example comprises a DFT circuit 35 (Fourier transform circuit) in place of the BPFs 32x and 32y, a level comparator 33d in place of the level comparator 33a, and an impedance controller 34d in place of the impedance controller 34a.

The operation of the read amplifier of the fourth example will be described only as to the difference from that of the first example.

The DFT circuit 35 outputs signal levels of a plurality of frequency components. The DFT circuit 35 receives an output from the first amplifying circuit 21a, to measure frequency characteristics, thereby enabling the entire band to be measured and adjusted.

The level comparator 33d compares the signal levels of the plurality of frequency components output from the DFT circuit 35. The impedance controller 34d generates a control signal to the first amplifying circuit 21a based on an output from the level comparator 33d to optimize the input impedance Rin in the first amplifying circuit 21a. In the case where the read head and the read amplifier show the above-described read band simulation result, the impedance controller 34d decreases the input impedance Rin if the level of a high frequency component is high and finishes the adjustment of the input impedance Rin when the level of the high frequency component is decreased down to a level of a low frequency component.

The read amplifier of the fourth example may comprise a circuit capable of measuring other frequency characteristics such as an FFT circuit in place of the DFT circuit 35.

In the first to fourth examples, the preamplifier is adjusted assuming that the target read band is flat. Otherwise, the target read band may have characteristics emphasizing a band higher than a predetermined frequency so that the RDC 12 can readily analyze a signal having a high transfer rate. Alternatively, the read amplifier may have a function of precisely adjusting the read band to achieve the target read band (equalizer) on a rear stage.

When the preamplifier 11 after being mounted on the HDD comprises the circuit for adjusting the read band as described above, redundant modification of the preamplifier or the transmission path can be eliminated. The preamplifier can optimally adjust the read band even if the transmission path is different so that the preamplifier can be commonly used in the HDDs of different kinds.

Incidentally, the converting amplifier 31, the BPFs 32x, 32y, and 32z, the DFT circuit 35, the level comparators 33a, 33b, 33c, and 33d, and the impedance controllers 34a, 34b, 34c, and 34d correspond to the band adjusting circuit 24. Of these components, the converting amplifier 31, the BPFs 32x, 32y, and 32z, and the level comparators 33a, 33b, 33c, and 33d serve as detectors.

Although the embodiment is described above as being applied to HDD, it may be applied to a signal amplifier in a storage device for driving a storage medium such as a flexible disk or an optical disk.

As set forth hereinabove, according to the embodiment, it is possible to adjust the frequency characteristics of the read signal.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal amplifier that amplifies a read signal read from a storage medium by a head, the signal amplifier comprising:
an amplifier configured to amplify the read signal received from the head to obtain an amplified signal, and vary input impedance of the read signal based on a control signal;
a detector configured to detect frequency characteristic of the amplified signal output from the amplifier and determine the frequency characteristic as a first frequency characteristic; and
an impedance controller configured to generate the control signal such that the first frequency characteristic detected by the detector becomes a predetermined second frequency characteristic.

2. The signal amplifier according to claim 1 further comprising an amplitude adjustor configured to adjust a level of the amplified signal to be constant.

3. The signal amplifier according to claim 1, wherein the first frequency characteristic includes signal levels of a predetermined plurality of frequencies in the amplified signal.

4. The signal amplifier according to claim 3, wherein the second frequency characteristic includes a relationship between the signal levels of the frequencies.

5. The signal amplifier according to claim 4, wherein the impedance controller is configured to compare the signal levels of the frequencies in the amplified signal, and generate the control signal based on a comparison result and the second frequency characteristic.

6. The signal amplifier according to claim 5, wherein the detector comprises a filter configured to allow the frequencies to pass through, and detect the signal levels of the frequencies obtained by the filter.

7. The signal amplifier according to claim 5, wherein the detector comprises a Fourier transform circuit, and detect the signal levels of the frequencies obtained by the Fourier transform circuit.

8. The signal amplifier according to claim 3, wherein predetermined information is a signal added with sinusoidal waves of the frequencies or a random pattern.

9. The signal amplifier according to claim 8, wherein the predetermined information is written to the storage medium by an alternating-current erase.

10. The signal amplifier according to claim 1, wherein the impedance controller is configured to generate the control signal based on a preset relationship between the first frequency characteristic and the control signal and the first frequency characteristic detected by the detector.

11. The signal amplifier according to claim 10, wherein
the amplifier comprises a variable current source capable of varying a current value based on the control signal,
the input impedance is determined based on the current value of the variable current source, and
the control signal specifies the current value of the variable current source.

12. The signal amplifier according to claim 10, wherein the amplifier comprises a variable resistance capable of varying a resistance value based on the control signal,
the input impedance is determined based on the resistance value of the variable resistance, and
the control signal specifies the resistance value of the variable resistance.

13. The signal amplifier according to claim 1, wherein the second frequency characteristic is flat over a predetermined band.

14. The signal amplifier according to claim 1, wherein the second frequency characteristic emphasizes a band of a predetermined frequency or higher in bands of the second frequency characteristic.

15. A storage device comprising:
an instructing module configured to instruct to read predetermined information on a storage medium;
a head configured to read the information and output the information as a read signal;
an amplifier configured to amplify the read signal received from the head to obtain an amplified signal, and vary input impedance of the read signal based on a control signal;
a detector configured to detect frequency characteristic of the amplified signal output from the amplifier and determine the frequency characteristic as a first frequency characteristic; and
an impedance controller configured to generate the control signal such that the first frequency characteristic detected by the detector becomes a predetermined second frequency characteristic.

16. The storage device according to claim 15, wherein the instructing module is configured to store, in a nonvolatile storage medium, a set value indicating the control signal generated by the impedance controller.

17. The storage device according to claim 16, wherein
the instructing module is configured to acquire the set value stored in the nonvolatile storage medium, and
the impedance controller is configured to generate the control signal based on the set value acquired by the instructing module.

18. The storage device according to claim 17, wherein the instructing module is configured to acquire the set value stored in the nonvolatile storage medium at start up of the storage device.

19. The storage device according to claim 16, wherein the instructing module is configured to issue an instruction to read the information when a predetermined time period has elapsed, and store the set value indicating the control signal generated by the impedance controller in the nonvolatile storage medium in response to the instruction.

20. The storage device according to claim 16, wherein the nonvolatile storage medium is the storage medium.
